(19) United States
(12) Patent Application Publication
(10) Pub. No.: US 2014/0298200 A1
(43) Pub. Date: Oct. 2, 2014

(54) PROVIDING USER INTERFACE ELEMENTS FOR INTERACTIVE SESSIONS

(71) Applicant: Google Inc., Mountain View, CA (US)

(72) Inventor: Michal Cierniak, Palo Alto, CA (US)

(21) Appl. No.: 13/853,698

(22) Filed: Mar. 29, 2013

(51) Int. Cl. H04L 29/06

(52) U.S. Cl. CPC H04L 65/403
USPC 715/753

(57) ABSTRACT

Methods, systems, and apparatus, including computer programs encoded on a computer storage medium, for providing user interface elements for interactive sessions. In one aspect, a method includes identifying prior session data, identifying prior configuration data associated with a set of user interface elements employed during prior interactive sessions, beginning a new interactive session belonging to one or more corresponding session categories, selecting one or more user interface elements to be presented during the new interactive session, based at least in part on an analysis of the prior session data and the prior configuration data associated with the corresponding session category to which the new interactive session belongs, and providing data identifying the one or more selected user interface elements in response to an indication of a user's intention to begin the new interactive session.

### BACKGROUND

This specification relates to data processing and content distribution.

The Internet facilitates exchange of information between users across the globe. This exchange of information enables service providers to provide services to users that are not located in the same geographic regions as the service provider. Similarly, users that are interested in obtaining services over the Internet can identify service providers without limiting their search to local service providers.

### SUMMARY

Users can participate in interactive sessions in which various tasks are performed. For example, a user that is interested in being tutored in math can participate in an interactive session that connects the user with a math tutor. As another example, a user that is interested in touring a museum can participate in a vicarious tourism session. During an interactive session, for example, session participants may add or remove user interface elements from a default configuration to facilitate the session. For example, during a math tutoring session, a student or tutor may add a shared whiteboard user interface element. During a vicarious tourism session, for example, a tourist or session guide may add a map panel user interface element.

Information associated with changes to user interfaces by session participants during interactive sessions can be stored and analyzed to identify a user interface configuration that may be suitable for sessions of a particular category, and/or sessions including a particular type of participant, a particular participant, particular session content, and/or types of devices. In general, if a statistically significant correlation is identified between prior session attributes and a particular interface element configuration, the configuration can be provided for new interactive sessions that are identified as being similar (e.g., in terms of session category, session participants, session content, and/or session devices) to the prior sessions. For example, if most tutoring sessions have included a whiteboard user interface element, the element can be provided at the beginning of or during a new tutoring session. As another example, if most vicarious tourism sessions have included a map panel user interface element, the element can be provided at the beginning of or during a new vicarious tourism session.

According to one innovative aspect of the subject matter described in this specification, a method includes identifying prior session data, identifying prior configuration data associated with a set of user interface elements employed during prior interactive sessions, beginning a new interactive session belonging to one or more corresponding session categories, selecting one or more user interface elements to be presented during the new interactive session, based at least in part on an analysis of the prior session data and the prior configuration data associated with the corresponding session category to which the new interactive session belongs, and providing data identifying the one or more selected user interface elements in response to an indication of a user's intention to begin the new interactive session.

Other embodiments of these aspects include corresponding systems, apparatus, and computer programs, configured to perform the actions of the methods, encoded on computer storage devices.

These and other embodiments may each optionally include one or more of the following features. For instance, receiving a search query associated with a particular task, where a session category is associated with the new interactive session, based at least in part on the search query; identifying one or more tasks performed during the new interactive session, where a session category is associated with the new interactive session, based at least in part on the tasks; identifying content associated with the new interactive session, where a session category is associated with the new interactive session, based at least in part on the content; identifying a participant associated with the new interactive session, where a session category is associated with the new interactive session, based at least in part on the participant; selecting one or more user interface elements is based at least in part on an analysis of a portion of the prior session data and the prior configuration data associated with prior interactive sessions in which the user has previously participated; receiving information associated with a context of a computing device employed by the user, where selecting one or more user interface elements is based at least in part on an analysis of a portion of the prior session data and the prior configuration data associated with prior interactive sessions in which similar computing devices were used in a similar context; the one or more user interface elements are to be presented to the user by default, at the beginning of the new interactive session; the analysis of the prior session data and the prior configuration data includes submitting session parameters and configuration parameters to a machine learning model, and selection of one or more user interface elements occurs when a confidence value produced by the machine learning model exceeds a predetermined confidence threshold; receiving, from the user, a selection of one or more user interface elements to be employed during the new interactive session; storing, with the prior session data and prior configuration data, session data associated with the new interactive session and configuration data associated with the one or more user interface elements selected by the user during the new interactive session; and reanalyzing the prior session data and prior configuration data.

Other embodiments of this aspect include corresponding systems, apparatus, and computer programs, configured to perform the actions of the methods, encoded on computer storage devices. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the actions.

Particular embodiments of the subject matter described in this specification can be implemented so as to realize one or more of the following advantages. Suitable user interface elements to be employed during interactive sessions can be automatically selected for a user and presented to the user, saving time when launching a session. Potentially useful interface elements can be presented or recommended based on prior session data collected from multiple users, thus collectively improving the experience of all of the users over time. User interfaces do not need to be initially designed for all session types; instead, efficient user interfaces emerge, thereby saving developmental resources.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system in which user interface elements are provided for interactive sessions.

FIG. 2 is a block diagram illustrating an example user interface element providing technique.

FIG. 3 is a screenshot of an example user interface in which an intention to begin an interactive session may be provided.

FIG. 4 is a screenshot of an example user interface including user interface elements.

FIG. 5 is a flow chart of an example process for providing user interface elements for interactive sessions.

FIG. 6 is a block diagram of an example data processing apparatus.

Like reference numbers and designations in the various drawings indicate like elements.

### DETAILED DESCRIPTION

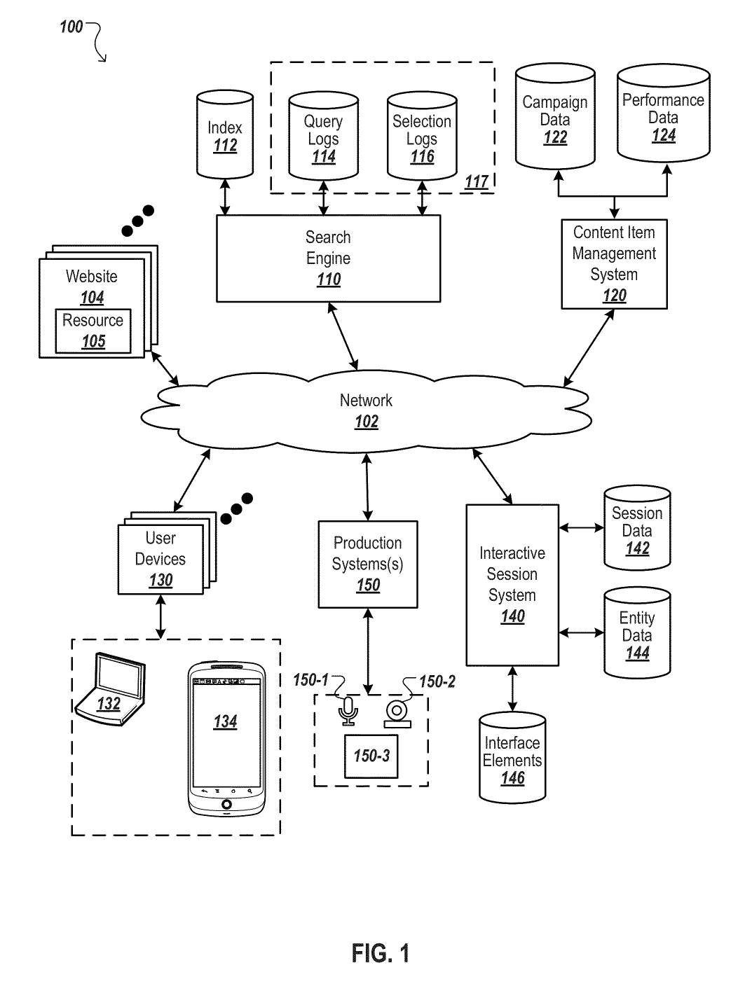

FIG. 1 is a block diagram of an example environment 100 in which user interface elements are provided for interactive sessions. A data communication network 102 enables data communication between multiple electronic devices. Users can access content, provide content, exchange information, and participate in interactive sessions by use of the devices and systems that can communicate with each other over the network 102. The network 102 can include, for example, a local area network (LAN), a cellular phone network, a wide area network (WAN), e.g., the Internet, or a combination of them. The links on the network can be wireline or wireless links or both.

A publisher website 104 includes one or more resources 105 associated with a domain and hosted by one or more servers in one or more locations. Generally, a website is a collection of web pages formatted in hypertext markup language (HTML) that can contain text, images, multimedia content, and programming elements, for example, scripts. Each website 104 is maintained by a content publisher, which is an entity that controls, manages and/or owns the website 104.

A resource is any data that can be provided by a publisher website 104 over the network 102 and that has a resource address, e.g., a uniform resource locator (URL). Resources may be HTML pages, electronic documents, images files, video files, audio files, and feed sources, to name just a few. The resources may include embedded information, e.g., meta information and hyperlinks, and/or embedded instructions, e.g., client-side scripts.

In operation, a search engine 110 crawls the publisher web sites 104 and indexes the resources 105 provided by the publisher web sites 104 in an index 112. The search engine 110 can receive queries from user devices 130. In response to each query, the search engine 110 searches the index 112 to identify resources and information that are relevant to the query. The search engine 110 identifies the resources in the form of search results and returns the search results to the user device 130. A search result is data generated by the search engine 110 that identifies a resource or provides information that satisfies a particular search query. A search result for a resource can include a web page title, a snippet of text extracted from the web page, and a resource locator for the resource, e.g., the URL of a web page.

The search results are ranked based on scores related to the resources identified by the search results, e.g., information retrieval (“IR”) scores, and optionally a separate ranking of each resource relative to other resources, e.g., an authority score. The search results are ordered according to these scores and provided to the user device according to the order.

A user device 130 receives the search results and presents them to a user. If a user selects a search result, the user device 130 requests the corresponding resource. The publisher of the web site 104 hosting the resource receives the request for the resource and provides the resource to the user device 130.

In some implementations, the queries submitted from user devices 130 are stored in query logs 114. Selection data for the queries and the web pages referenced by the search results and selected by users are stored in selection logs 116. The query logs 114 and the selection logs 116 define search history data 117 that include data from and related to previous search requests associated with unique identifiers. The selection logs represent actions taken responsive to search results provided by the search engine 110. The query logs 114 and selection logs 116 can be used to map queries submitted by user devices to resources that were identified in search results and the actions taken by users when presented with the search results in response to the queries. In some implementations, data are associated with the identifiers from the search requests so that a search history for each identifier can be accessed. The selection logs 116 and query logs 114 can thus be used by the search engine to determine the respective sequences of queries submitted by the user devices, the actions taken in response to the queries, and how often the queries have been submitted.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The content item management system 120 provides content items for presentation with the resources 105. A variety of appropriate content items can be provided—one example content item is an advertisement. In the case of advertisements, the content item management system 120 allows advertisers to define selection rules that take into account attributes of the particular user to provide relevant advertisements for the users. Example selection rules include keyword selection, in which advertisers provide bids for keywords that are present in either search queries or resource content or metadata. Advertisements that are associated with keywords having bids that result in an advertisement slot being awarded in response to an auction are selected for displaying in the advertisement slots.

When a user of a user device 130 selects an advertisement, the user device 130 generates a request for a landing page of the advertisement, which is typically a web page of the advertiser. The relevant advertisements can be provided for presentation on the resources 105 of the publishers 104, or on a search results page resource. For example, a resource 105 from a publisher 104 may include instructions that cause a user device to request advertisements from the content item management system 120. The request includes a publisher identifier and, optionally, keyword identifiers related to the content of the resource 105. The content item management system 120, in turn, provides advertisements to the requesting user device. With respect to a search results page, the user device renders the search results page and sends a request to the content item management system 120, along with one or more keywords related to the query that the user provide to the search engine 110. The content item management system 120, in turn, provides advertisements to the requesting user device.

In the case of advertisements, the content item management system 120 includes a data storage system that stores campaign data 122 and performance data 124. The campaign data 122 stores advertisements, selection information, and budgeting information for advertisers. The performance data 124 stores data indicating the performance of the advertisements that are served. Such performance data can include, for example, click-through rates for advertisements, the number of impressions for advertisements, and the number of conversions for advertisements. Other performance data can also be stored.

The campaign data 122 and the performance data 124 are used as input to an advertisement auction. In particular, the content item management system 120, in response to each request for advertisements, conducts an auction to select advertisements that are provided in response to the request. The advertisements are ranked according to a score that, in some implementations, is proportional to a value based on an advertisement bid and one or more parameters specified in the performance data 124. The highest ranked advertisements resulting from the auction are selected and provided to the requesting user device.

A user device 130 is an electronic device, or collection of devices, that is capable of requesting and receiving resources over the network 102. Example user devices 130 include personal computers 132, mobile communication devices 134, and other devices that can send and receive data over the network 102. A user device 130 typically includes a user application, e.g., a web browser, that sends and receives data over the network 102, generally in response to user actions. The web browser can enable a user to display and interact with text, images, videos, music and other information typically located on a web page at a website on the world wide web or a local area network.

An interactive session system 140 is also accessible by the user devices 130 over the network 102. The interactive session system 140 serves interactive sessions and data related to interactive sessions to users of user devices 130. The term “interactive session” is used in this specification to refer to a presentation that allows a user to experience an event or receive data related to the event. Events of different types can be presented. In some implementations, events may be “assistance” events, for which interactive sessions provide step-by-step assistance to users to accomplish a particular task, or events may be “experience” events, for which interactive sessions provide users with an experience of participating in an activity. An example interactive session for an assistance event is a session that describes a step-by-step process to build a computer. An example interactive session for an experience event is a session that provides the experience of driving a certain make and model of an automobile. The interactive session system 140 may also provide interactive sessions for other appropriate event types.

Furthermore, the data that the interactive session system 140 provides for an event may also differ based on the event type and based on the intent of the user. For example, interactive sessions for repair events may provide users with a list of tools and parts required to accomplish a task at the beginning of an interactive session. Likewise, a user may have implicitly or explicitly specified an intent for viewing an interactive session. The user may explicitly specify an intent, for example, by interacting with a user interface element that represents their intent. A user may implicitly specify an intent, for example, by submitting a search query that is related to the intent, or by requesting other information that is related to the intent. For example, a user request for information about purchasing tools needed to repair a computer may be considered an implicit indication of the user's intent to repair a computer.

The interactive session system 140 may also determine specific data to provide based on the intent. For example, a user that is viewing a session that describes building a computer, and with the intent to build the computer, may be presented with additional information, e.g., a list of parts, tools and the time required to complete the task. Another user that is watching the same session with the intent to learn about computers may be presented with other information, e.g., articles about memory, heat dissipation, or other computer-related topics, in a side panel of a viewing environment as the interactive session is presented.

The interactive sessions can be created by assistants, such as expert assistants, or non-expert users. An “assistant” can be a user or entity that has been accepted by the system 170 for a category, e.g., as a result of the user's or entity's having provided credentials or demonstrated a high level of skill. An “expert assistant” may be an assistant with a high level of skill or expertise in a particular area. Examples of expert assistants include a licensed contractor for construction related videos or a company that produces sessions for a particular product the company manufactures and a user that has produced a large number of highly rated sessions. An assistant does not have to have a particular level of skill or have produced a large number of highly rated sessions. For example, an assistant may simply be a friend or acquaintance of another user that knows how to accomplish a task, such as programming a universal remote control. This assistant and the other user can participate in an interactive session where the assistant helps the other user program a universal remote control.

In some implementations, the content item management system 120 can provide content items with the interactive sessions. In the case of advertisements, the content item management system 120 may select advertisements based on the subject matter of a session, the event type, and the user's intent. For example, for a repair event, the content item management system 120 may provide advertisements for providers of tools and parts that are listed in the list of tools and parts required to accomplish the repair task.

A user experiences a session by use of one or more user devices 130. Other types of input and output devices may also be used, depending on the type of interactive session. For example, an augmented reality visor that provides a view of a real-world environment augmented by computer-generated graphics may be used. A tactical sensory input device and a tactical sensory output device that applies pressure to a user's body and that the user interprets as simulated motion or other type of feedback may also be used.

Some interactive sessions may be provided as part of a consultation process, for example when the user cannot find a stored interactive session that fulfills the user's informational needs. To illustrate, an automobile mechanic may contact a user at another location, e.g., the user's home, to consult with the user regarding an automobile repair. The automobile mechanic may then explain to the user, by means of an interactive session that highlights certain parts of the automobile engine as seen from the point of view of the automobile mechanic, certain repairs that are necessary and request authorization from the user to proceed. The user can ask questions and discuss alternatives with the automobile mechanic during the interactive session to make an informed decision.

Production systems 150 can be used to create sessions. Production systems 150 may range from studios to simple hand-held video recording systems. Generally, a production system 150 is a system that includes one or more of an audio input device 150-1, a video input device 150-2, an optional display device 150-3, and optionally other input and output devices and production processes that are used to create sessions. For example, post production processes may be used to add metadata to an interactive session. Such metadata may include, for example, keywords and topical information that can be used to classify the session to one or more topical categories; a list of tools and parts required for a particular session and descriptions of the tools and parts; and so on.

Tactical sensory input devices may also be used in a production system 150. For example, a particular interactive session may provide input data for a “G-suit” that applies pressure to a user's body and that the user interprets as simulated motion. Accordingly, appropriate input systems are used in the production system 150 to generate and store the input data for the interactive session.

Production systems 150 may also be or include devices that are attached to a person. For example, for “point of view” sessions, wearable computer devices that include a camera input device and microphone input device may be worn on a user's person during the time the user is creating the session.

The sessions are stored as sessions data 142 and are associated with authoring entities by entity data 144. The sessions data 142 can include configuration data associated with user interface elements 146 employed by assistants and users during each of the sessions. Generally, user interface elements may include software-based components (e.g., controls, gadgets, widgets, etc.) which may be selected and used to facilitate an interactive session. For example, when conducting a tutoring session with a user, an assistant may employ a whiteboard user interface element to be shared with the user. As another example, when engaging in a driving experience session, a user may select a speedometer gadget interface, and may position the gadget interface within a main session interface. Configuration data associated with the interface elements 146, for example, may include information related to the selection and use of the interface elements, such as selection times, dismissal times, positioning, and other user interactions with the elements during an interactive session.

A user can use a user device 130 to access the interactive session system 140 to request a session. The interactive session system 140 can provide a user interface to the user devices 130 in which interactive sessions are arranged according to a topical hierarchy. Based on factors such as a session category, the session participants, and a current context of the user device 130, for example, the interactive session system 140 can analyze prior session data 142 and can select one or more interface elements 146 to be recommended or presented to the user. For example, if a particular math tutor has regularly selected a whiteboard user interface during previous tutoring sessions, the interactive session system 140 can automatically select and present the interface at the beginning of a new tutoring session. As another example, if users have usually selected a speedometer gadget interface during previous driving experience sessions and have usually positioned the gadget interface in a particular location within the main interface (e.g., the bottom-right corner), the interactive session system 140 can automatically select and appropriately position the gadget interface for a new user of the interactive session. In some implementations, the interactive session system 140 includes a search subsystem that allows users to search for interactive sessions. Alternatively, the search engine 110 can search the session data 142 and the entity data 144.

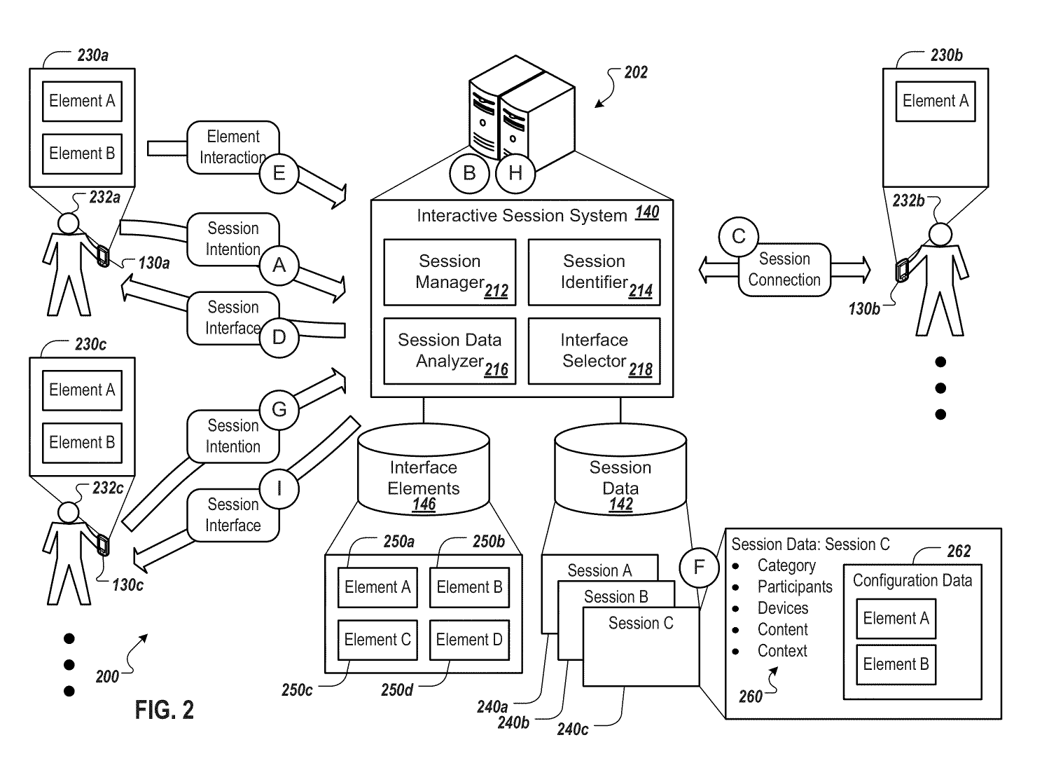

FIG. 2 is a block diagram 200 illustrating an example user interface element providing technique, and an example flow of data (shown in stages (A) to (I)), which may occur in the illustrated sequence, or may occur in a sequence that is different than in the illustrated sequence. As shown in the block diagram 200, for example, the interactive session system 140 can include data processing apparatus 202 (e.g., one or more servers or other computing devices), which may include one or more processors configured to execute instructions stored by a computer-readable medium for performing various operations, such as input/output, communication, data processing, etc. The interactive session system 140, for example, may communicate with stationary or portable computing devices 130a-c (e.g., servers, personal computers, smartphones, or other suitable computing devices) using wired and/or wireless network connections.

In the present example, the interactive session system 140 can provide user interfaces 230a-c to the respective devices 130a-c during interactive sessions for performing various tasks. To select and provide user interface elements which may be included by the user interfaces 230a-c, for example, the interactive session system 140 can use various hardware and/or software-based components to be executed by the data processing apparatus 202, including a session manager 212, a session identifier 214, a session data analyzer 216, and an interface selector 218. The session manager 212, for example, can manage interactive sessions and communications between the interactive session system 140 and the devices 130a-c. The session identifier 214, for example, can identify and/or filter session data 142 (e.g., maintained by a data store) associated with prior interactive sessions. The session data analyzer 216, for example, can analyze the session data 142 to identify data patterns and correlations between session categories, content, participants, and/or devices, and one or more user interface elements 146 deployed during prior interactive sessions. The interface selector 218, for example, can automatically select one or more user interface elements 250a-d to be presented during new interactive sessions, based at least in part on identified data patterns and correlations from prior sessions. The data patterns and correlations can be based on prior user- and assistant-selected user interface elements 250a-d from previous sessions, for example.

Referring to the example data flow, during stage (A), a user 232a can use the device 130a to provide an indication of an intention to begin an interactive session. For example, the user 232a can use a web browser provided by the device 130a to access a search page. In the present example, the user 232a can provide a search query (e.g., “math tutor”) to a search engine (e.g., the search engine 110, shown in FIG. 1), and can receive various search results, including one or more session request elements that may facilitate connecting the user to pre-recorded and/or real time interactive sessions (e.g., tutoring sessions). By interacting with (e.g., clicking) a session request element, for example, the user 232a can indicate an intention to immediately begin an interactive session, or to schedule the session for a future time.

During stage (B), the interactive session system 140 can receive and process the user's 232a indication of an intention to begin an interactive session. For example, the session manager 212 can receive information about a type of task (e.g., math tutoring) to be performed during the interactive session, and/or can receive information about one or more participants to be included in the session. The user 232a, for example, may indicate an intention to begin or to schedule an interactive session with an assistant 232b (e.g., a particular math tutor). With permission from the user 232a, for example, the session manager 212 may also receive information associated with the user's account information (e.g., an account identifier) and/or device 130a (e.g., device type, device peripherals, display size, general location, connection speed, etc.).

During stage (C), the interactive session system 140 can facilitate a connection between interactive session participants. For example, the session manager 212 may determine that the assistant 232b (e.g., the user's math tutor) is presently available for an interactive session. The session manager 212, for example, can facilitate a network connection between the user's device 130a and the assistant's device 130b.

During stage (D), the interactive session system 140 can provide user interfaces to the interactive session participants. User interfaces provided by the interactive session system 140, for example, may include various user interface elements (e.g., software-based components, such as controls, gadgets, widgets, etc.) which may be selected and used during the interactive session. The selections can be specified automatically, or can be specified by the session participants, or both. To assist the user 232a in discovering suitable user interface elements when beginning an interactive session, for example, the interactive session system 140 can identify one or more relevant prior interactive sessions, and can analyze the corresponding prior session data to identify data patterns and correlations between session categories, content, participants, and/or devices, and one or more user interface elements employed during the prior interactive sessions. In general, user interface elements that have been employed in prior interactive sessions identified as being similar to a new interactive session (e.g., prior sessions of a similar category as a new session, prior sessions including similar content as the new session, prior sessions having one or more participants in common with the new session or having participants that share common demographic attributes with a participant in the new session, and/or prior sessions including devices having one or more attributes in common with a device included in the new session) can be automatically recommended or presented during the new session.

In the present example, the session identifier 214 may identify sessions 240a (Session A) and 240b (Session B) as prior interactive sessions that have been facilitated by the interactive session system 140. The session identifier 214, for example, can provide the identified session data for Sessions A and B to the session data analyzer 216 for analysis. Upon analyzing the prior session data associated with Sessions A and B, for example, the session data analyzer 216 may identify one or more statistically significant correlations between various session data attributes (e.g., category, participants, devices, content, and context) and the use of one or more user interface elements during the sessions. For example, the session data analyzer 216 may identify a correlation between a particular session participant (e.g., the user 232a and/or assistant 232b) and/or session category (e.g., a math tutoring session) and the use of a particular user interface element (e.g., user interface element 250a). A variety of appropriate machine learning, data mining, and statistical analysis processes can be used to identify such correlations.

In the present example, the user interface element 250a (e.g., a shared whiteboard control) can be selected by the interface selector 218 from the interface elements 146, and can be provided to the user 232a and to the assistant 232b for presentation by the respective user interfaces 230a and 230b, at the beginning of an interactive session.

During stage (E), information related to user interactions with user interface elements can be received by the interactive session system 140. For example, during an interactive session (e.g., a tutoring session) between the user 232a and the assistant 232b, the user 232a (e.g., a math student) may select a user interface element 250b (e.g., a calculator gadget). Information related to the user interactions, for example, may include the time of selection or dismissal (e.g., relative to the start time of the interactive session), the positioning of the user interface element 250b within the user interface 230a, and/or the content/context of the interactive session at the time of selection or dismissal—such as, other user interface elements that may be included in the user interface 230a, content that may be associated with the other user interface elements, the type and content of communications between the user 232a and the assistant 232b, and so on. In the present example, the user 232a may select the user interface element 250b at the beginning of a tutoring session.

During stage (F), user interaction information associated with user interface elements employed during an interactive session can be stored by the interactive session system 140 with prior session data 142. Upon the conclusion of (or during) an interactive session 240c (Session C), for example, the interactive session system 140 can store session data 260 associated with Session C, and can store configuration data 262 associated with interactions of the user 232a with user interface elements 250a (Element A) and 250b (Element B) employed by the user during Session C. Session data 260 associated with Session C, for example, can include data associated with the session category (e.g., tutoring, math tutoring, etc.), session participants (e.g., the user 232a and the assistant 232b), session devices (e.g., the device 130a and the device 130b), session content (e.g., communications between the user 232a and the assistant 232b that are agreed upon by both participants to be recordable), and/or session context (e.g., device location, device motion, connection speed, time of day, day of week, etc.). Configuration data 262 associated with Session C, for example, can include selection and dismissal times, positioning, and other user interactions with each of the user interface elements 250a (Element A) and 250b (Element B).

During stage (G), a user 232c (e.g., a returning user or a new user) can use the device 130c to provide an indication of an intention to begin an interactive session. For example, the user 232c can use an application provided by the device 130c to access a directory of interactive service providers. In the present example, the user 232c may indicate an intention to start an interactive session (e.g., a math tutoring session) with an assistant with expertise in a selected category (e.g., math tutoring).

During stage (H), the interactive session system 140 can receive and process the user's 232c indication of an intention to begin an interactive session. Similar to stage (B), for example, the session manager 212 can receive information about a type of task (e.g., math tutoring) to be performed during the interactive session, and/or can receive information about one or more participants to be included in the session. With permission from the user 232c, for example, the session manager 212 may also receive user account information (e.g., an account identifier) and/or device information (e.g., device type, device peripherals, display size, general location, connection speed, etc.). As with stage (C), for example, the interactive session system 140 can connect the user 232c with an assistant (e.g., the assistant 232b or another math tutor) when both participants are available, or the interactive session system 140 can provide the user 232c with a pre-recorded session.

During stage (I), the interactive session system 140 can provide the user interface 230c to the device 130c for presentation to the user 232c. In the present example, the session identifier 214 may identify sessions 240a (Session A), 240b (Session B), and 240c (Session C) as prior interactive sessions that have been facilitated by the interactive session system 140. The session identifier 214, for example, can provide the identified session data for Sessions A, B, and C to the session data analyzer 216 for analysis. Upon analyzing the prior session data associated with Sessions A, B, and C, for example, the session data analyzer 216 may identify one or more statistically significant correlations between various session data attributes (e.g., category, participants, devices, content, and context) and the use of one or more user interface elements during the sessions. Similar to stage (D), for example, the session data analyzer 216 may identify a correlation between the assistant 232b, the session category (e.g., a math tutoring session), and the use of the user interface element 250a (e.g., the shared whiteboard control). Further, in the present example, the session data analyzer 216 may now identify an additional correlation between the session category (e.g., a math tutoring session), the type of session user (e.g., a math student), and the use of the user interface element 250b (e.g., the calculator gadget). In the present example, the user interface element 250a (e.g., the shared whiteboard control) and the user interface element 250b (e.g., the calculator gadget) can be selected from the interface elements 146 by the interface selector 218, and can be provided to the device 130c for presentation through the user interface 230c at the beginning of the interactive session.

In general, operations associated with the stages (A) to (I) described in the example flow of data may be performed continually as various users and assistants access the interactive session system 140 and engage in interactive sessions. The interactive session system 140, for example, can continually add and maintain session data 142 as sessions occur. Over time, user interface elements 146 may be added, removed, or modified. As users and assistants employ existing, newly added, or newly modified interface elements 146, for example, usage patterns associated with the interface elements can be identified by the interactive session system 140, and can be used for automatically recommending or presenting the interface elements to users and assistants at opportune times. Since available user interface elements may change over time, and since different user interface elements may generally be useful during different types of interactive sessions, for different types of users, and/or for different types of devices, an adaptive technique for discovering and presenting interface elements may enhance a user's experience during an interactive session, based on the experiences of other users.

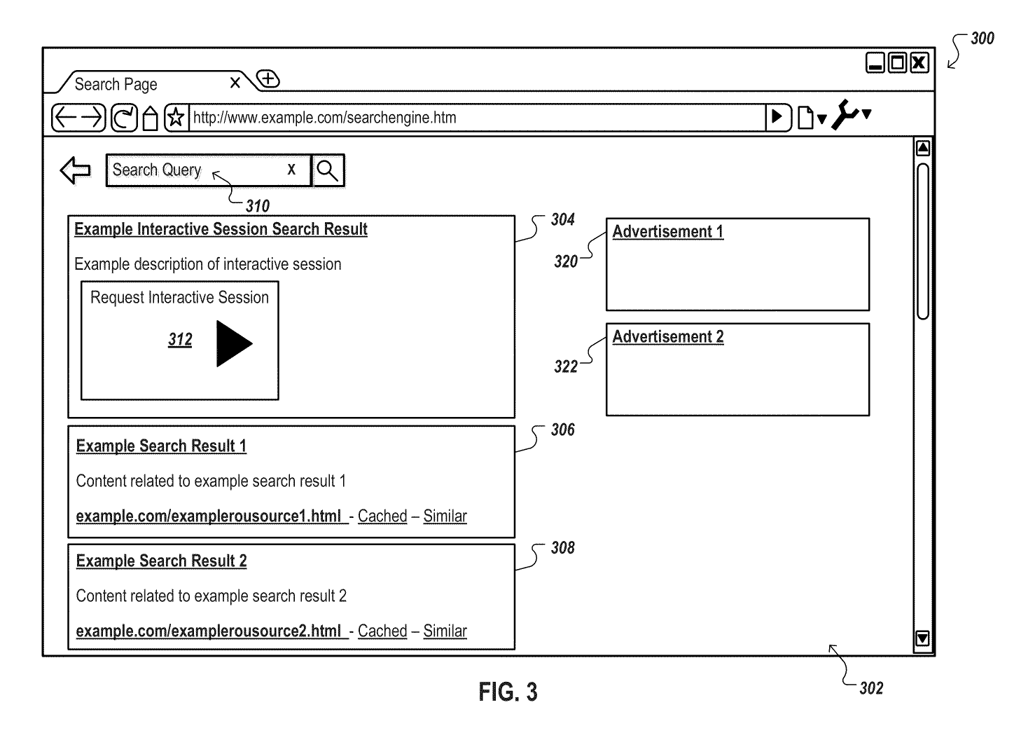

FIG. 3 is a screenshot of an example user interface 300 in which an intention to begin an interactive session may be provided. The user interface 300 is presenting an example search results page 302 in which example search results 304, 306, and 308 are displayed in response to submission of a search query 310. The example search results 306 and 308 are search results that reference web pages related to the search query 310, and user interaction with the search results 306 or 308 will redirect a user device to the web pages referenced by the respective search results.

The example search result 304 references an interactive session that has been identified as relevant to the search query 310. For example, the interactive session referenced by the search result 304 may include performance of the particular task that has been determined to be referenced by the search query 310, as described above. User interaction with the search result 304 can request a resource providing more information about the interactive session and/or request presentation of the interactive session.

For example, the search result 304 includes a session request element 312 that requests presentation of the interactive session in response to user interaction with (e.g., a user click of) the session request element 312. The search result 304 can also be created to include an active link that requests an interactive session scheduling page at which a user can schedule future presentation of a pre-recorded or real time interactive session. For example, user interaction with any portion of the search result 304 can initiate a request for the session scheduling page.

In response to receiving the search query 310, the search system (or the interactive session system) can submit a content item request to a content item management system. The content item request can include data specifying one or more of the search query, the particular task referenced by the search query, one or more interactive sessions in which the particular task is performed, a list of required implements for the particular task, a list of optional implements for the particular task, and/or a set of implements that the user has used during previous interactive sessions or that the user has otherwise identified as implements that are possessed by the user. Using the data in the content item request, the content item management system can select advertisements 320 and 322 (or other content items), for example, for presentation with the search results page.

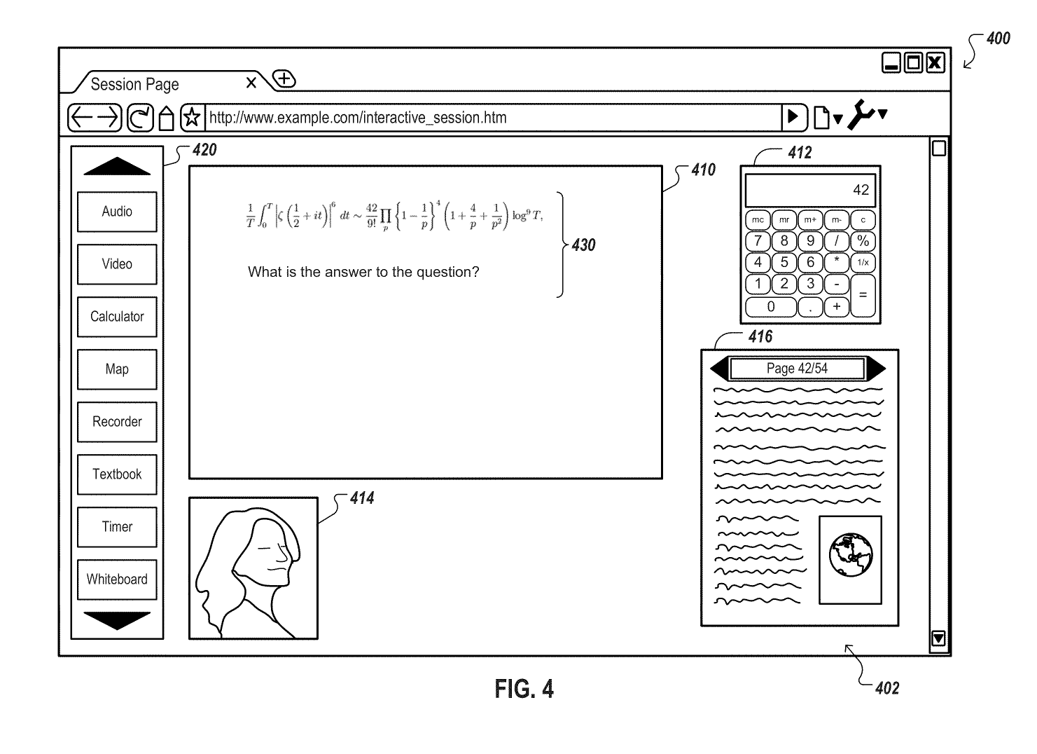

FIG. 4 is a screenshot of an example user interface 400 including user interface elements. The user interface 400 is presenting an example interactive session page 402 in which example user interface elements 410, 412, 414, and 416 are employed. Presentation of the user interface elements 410, 412, 414, and 416, for example, may occur automatically (e.g., based at least in part on data provided by the interactive session system 140), or may occur based on user input. For example, during an interactive session, a user may select one or more interface elements from a list 420 (e.g., graphical controls including text and/or graphic descriptions) of available interface elements. Data describing the user input and selections may be used by the interactive session system 140, for example, to further modify the automatic selections of user interface elements in future sessions.

The user interface 400, for example, can be presented to a user by a stationary or portable computing device (e.g., the devices 130a-c, shown in FIG. 2) during an interactive session. The interactive session, for example, may begin when the interactive session system 140 receives an indication of a user's intention to begin a new interactive session (e.g., when a user selects the session request element 312, shown in FIG. 3.) As another example, the interactive session may begin at a scheduled time after receiving the indication of the user's intention to begin the interactive session.

In general, prior to beginning and/or during an interactive session, the interactive session system 140 can identify one or more user interface elements to be presented to a session user by the user interface 400, based at least in part on attributes of the session, participants and/or devices. In the present example, the interactive session system 140 may identify a particular session that is about to begin as being a math tutoring session, may identify a session user as being a math student, and may identify a session assistant as being a math tutor. Based on the participation of the session assistant, for example, the interactive session system 140 can provide instructions for the user interface 400 to present the interface element 410 (e.g., a shared whiteboard control) at the beginning of the session, since the particular session assistant has usually selected the element for presentation during her sessions. Based on the session category (e.g., a math tutoring session) and/or the participation of a particular type of user (e.g., a math student), for example, the interactive session system 140 can provide instructions for the user interface 400 to present the interface element 412 (e.g., a calculator) in the upper-right hand corner of the interface 400 at the beginning of the session, since users of a similar type (e.g., math students) have usually selected the element for presentation during prior sessions of a similar category (e.g., math tutoring sessions), and have usually positioned the interface element 412 in a similar location.

During the interactive session, data associated with interface element interactions may be provided to the interactive session system 140. In the present example, the user may interact with the list 420 to indicate that the interface element 414 (e.g., a control for presenting video of the assistant during the session) is to be presented by the user interface 400. Data associated with the user's selection of the interface element 414, for example, can be stored by the interactive session system 140 as session data 142, and can be used to identify possible correlations between sessions and employment of the interface element by users. For example, based on an aggregation and analysis of prior session data, the interactive session system 140 may determine that a particular type of user (e.g., math students) generally employ the interface element 414 (e.g., the video presentation control) during a particular session category (e.g., math tutoring sessions).

By analyzing the session data 142, for example, the interactive session system 140 may identify user interactions with user interface elements, or may identify a lack of user interaction. For example, if the user were to not interact with the automatically presented user interface element 412 (e.g., the calculator) for the duration of the interactive session, the interactive session system 140 may interpret such a lack of interaction as if the interface element 412 were dismissed by the user, or as if the element had not been included in the session. Thus, in the present example, automatic presentation of the interface element 412 may eventually be discontinued for future interactive sessions, based on the non-interaction of various users with the element.

During the interactive session, instructions for the user interface 400 to present and/or modify interface elements may be received from the interactive session system 140. For example, the assistant may provide content 430 (e.g., text, graphics, questions, answers, etc.) to be shared with the user through the interface element 410 (e.g., the shared whiteboard control). Based on the session content, for example, the interactive session system 140 may identify one or more user interface elements to be presented to the user during the session. In the present example, the interactive session system 140 may identify a statistically significant correlation between particular session content (e.g., a question posed by the assistant) and the employment of the interface element 416 (e.g., a reference text). Thus, in the present example, the interactive session system 140 may provide instructions for the user interface 400 to present the interface element 416 to the user, and may provide instructions for the interface 400 to modify (e.g., navigate to relevant content) the interface element 416, based on prior interface modifications performed by users during prior sessions.

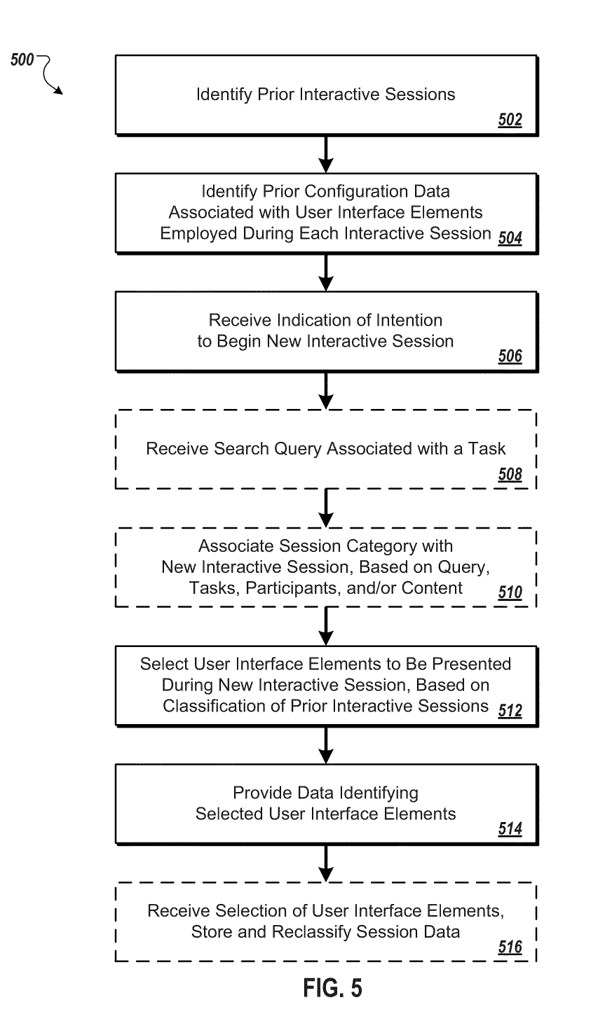

FIG. 5 is a flow chart of an example process 500 for providing user interface elements for interactive sessions. The process 500 can be performed, for example, by one or more of the interactive session system 140, the search engine 110, and/or another data processing apparatus. The process 500 can also be implemented as instructions stored on computer storage medium. Execution of the instructions by a data processing apparatus can cause the data processing apparatus to perform the operations of the process 500. In general, the process 500 can include identifying prior interactive session data, receiving an indication to begin a new interactive session, selecting one or more user interface elements to be presented during the new interactive session, and providing data identifying the selected user interface elements.

Prior session data associated with a set of prior interactive sessions are identified (502). Referring to FIG. 2, for example, the session identifier 214 can identify prior session data 142 associated with the prior interactive sessions 240a (Session A) and 240b (Session B). Each interactive session can be an online session during which a task was performed. For example, various users (e.g., the users 232a and 232c) and assistants (e.g., the assistant 232b) may have previously engaged in interactive sessions, during which various tasks (e.g., tutoring, tourism, consultation, etc.) may have been performed. Prior session data, for example, can include data associated with session categories, session participants, session content, session context, and/or session devices, and can include configuration data associated with one or more user interface elements employed during the sessions. The user interface elements employed during the sessions may have been automatically selected, for example, or selected by session participants, or be a combination of such selected user interface elements.

For each interactive session in the set of prior interactive sessions, prior configuration data associated with a set of user interface elements employed during the interactive session are identified (504). For example, the session identifier 214 can identify prior configuration data for each of the prior interactive sessions 240a (Session A) and 240b (Session B). Prior configuration data, for example, can include data associated with the user interface elements 146, such as element identifiers, the selection and dismissal times of the interface elements by session users and assistants, the positioning of the interface elements, and other relevant data.

An indication of an intention to begin a new interactive session belonging to a corresponding session category is received (506) from a user. For example, the user 232a can use the device 130a to interact with (e.g., click) a user interface element associated with a session request, and the device 130a can provide information (e.g., a session category identifier, a session title or description, a list of session participants, etc.) associated with the session request to be received by the session manager 212. In general, a session may be associated with one or more corresponding session categories (e.g., tutoring, tourism, consultation, etc.) before the session begins (e.g., based on a user definition, a title or description, one or more session participants, etc.), or session categorization may occur during the session (e.g., based on tasks performed during the session and/or based on session content).

In some implementations, a search query associated with a particular task may be received (508). For example, the user 232a can submit a search query for a particular category of interactive session (e.g., a “math tutoring session”) or a particular type of assistant (e.g., a “math tutor”). Information associated with the search query (e.g., a search query string, one or more search keywords, search result information, etc.) can be received by the session manager 212, for example.

In some implementations, a session category may be associated (510) with the new interactive session, based on one or more of a search query, a session task, session participants, and/or session content. In general, session categorization may be based on session identifiers or descriptions, and/or may be based on search queries submitted by users for identifying interactive sessions, one or more session participants, and/or content included in interactive sessions. To identify a session category of a new interactive session, for example, the session identifier 214 can use session category information associated with the session (e.g., a session category assigned to the session when defining or setting up the session), or can identify a session category based on its title or description. For example, a session with a description of “college math tutoring” may be categorized as a “tutoring session”, and/or as one or more sub-categories (e.g., “math tutoring session” or “college math tutoring session”).

Identifying a session category may be based at least in part on identifying an interactive session category related to a search query. For example, an interactive session identified through the provision of a search query (e.g., “math tutoring session”) may be categorized based on one or more keywords included in the query (e.g., “math tutoring”), or based on results associated with the query, such as links to interactive sessions. Search query and result information can be provided to the session identifier 214 by the search engine 110 (shown in FIG. 1), for example.

Identifying a session category may be based at least in part on identifying tasks and/or content associated with a new interactive session. For example, the session assistant 232b may specify that an interactive session is to include one or more implements (e.g., tools, devices, etc.), is to involve one or more tasks (e.g., conversation, problem solving, etc.), and/or is to employ one or more user interface elements (e.g., shared whiteboards, reference texts, etc.). The session identifier 214, for example, can categorize the interactive session prior to the beginning of the session based on the implements, tasks, and/or interface elements. In some implementations, session categories may be identified or refined during an interactive session, based on tasks performed during the session and/or based on the use of particular user interface elements. For example, if the session assistant 232b refers to a particular topic or uses particular interface element (e.g., a math reference text) during the interactive session, the session identifier 214 may categorize the interactive session as a “math tutoring session”.

Identifying a session category may be based at least in part on identifying one or more session participants of a new interactive session. For example, if the user 232a is associated with profile information that identifies the user as a particular user type (e.g., a student), and the assistant 232b is associated with profile information that identifies the assistant as a particular type of assistant (e.g., a tutor), the session identifier 214 can identify the session category based on the user/assistant types, or based on a relationship between the types. The session identifier 214, for example, can access the session data 142 to determine that prior interactive sessions between “student” user types and “tutor” assistant types have generally been categorized as “tutoring sessions”, and can categorize the new session based on the prior categorizations.

Computing device context information can be received prior to the beginning of and/or during a new interactive session. In the present example, the session manager 212 can receive context information (e.g., device location, device motion, connection speed and quality, etc.) from the devices 232a and 232b prior to the beginning of the tutoring session, and during the tutoring session. Device type information may also be received by the session manager 212 from session devices—for example, the devices 232a and 232b may identified as stationary desktop computers, as mobile tablet computers, or as other sorts of devices.

One or more user interface elements to be presented to the user during the new interactive session are selected (512), based at least in part on an analysis of the prior session data and the prior configuration data associated with the corresponding session category to which the new interactive session belongs. For example, the session data analyzer 216 can analyze the prior session data 142 (e.g., session data for the prior interactive sessions 240a and 240b), and prior configuration data associated with the employment of the user interface elements 146 by users and assistants during the prior interactive sessions. One or more of the user interface elements 146, for example, may be selected by the interface selector 218 for recommendation or presentation to the user 232a and/or to the assistant 232b through the respective interfaces 230a and 230b. In general, user interface selection may be based on various session attributes, including session category, session participants, session content, and session devices. The session attributes may be analyzed by the session analyzer 216, for example, alone or in combination with other attributes.

In some implementations, the analysis of prior session and configuration data may include submitting session and configuration parameters to a machine learning model (e.g., a model that uses classification techniques, association rules, cluster analysis, neural networks, or other suitable techniques). Session parameters, for example, may include session category identifiers, session participant identifiers, session content types, and/or session device types and device context data. Configuration parameters, for example, may include user interface element identifiers and may include codified representations of user interactions with interface elements. For example, a codified representation may indicate that a user has selected a user interface element within a particular timeframe (e.g., within the first minute of an interactive session), and that the user has positioned the interface element at a particular location (e.g., in the upper-right quadrant of an interface). In general, selection of one or more user interface elements may occur when a confidence value produced by the machine learning model exceeds a predetermined confidence threshold. For example, if the session data analyzer 216 determines, with a confidence level over the predetermined threshold (e.g., 70%, 80%, 90%, or another suitable value), that a particular user interface element (e.g., the user interface element 250a) has been employed during prior interactive sessions associated with a particular set of parameters, the interface selector 218 may select the user interface element for new interactive sessions associated with the same set of parameters.

In some implementations, selecting one or more user interface elements may be based at least in part on an analysis of a portion of the prior session and configuration data associated with prior interactive sessions in which tasks of a category similar to that of a new interactive session were performed. For example, the session data analyzer 216 can analyze session data 142 associated with prior sessions of a particular category (e.g., tutoring) and can identify a set of user interface elements generally employed during the sessions. When a new interactive session of a similar category (e.g., math tutoring) begins, for example, the interface selector 218 can select one or more interface elements 146 that were employed during the prior sessions.

In some implementations, selecting one or more user interface elements may be based at least in part on an analysis of a portion of the prior session and configuration data associated with prior interactive sessions in which a particular user (or users of a similar type) had previously participated. For example, the session data analyzer 216 can analyze session data 142 associated with prior sessions in which the user 232a and/or the assistant 232b have participated and can identify a set of user interface elements generally employed by the user 232a and/or the assistant 232b during the sessions. When a new interactive session including the user 232a and/or the assistant 232b begins, for example, the interface selector 218 can select one or more interface elements 146 that were employed during the prior sessions.

In some implementations, selecting one or more user interface elements may be based at least in part on an analysis of a portion of the prior session and configuration data associated with prior interactive sessions in which computing devices were used in contexts similar to a computing device and context of a new interactive session. The session data analyzer 216, for example, can analyze session data 142 associated with prior sessions in which devices similar to (e.g., of a similar type or model) the device 130a have been used, or in which device context (e.g., location, mobility, connection speed and/or quality) has been similar. When a new interactive session including the device 130a begins, for example, the interface selector 218 can select one or more interface elements 146 that were employed on similar devices in a similar context. For example, some interface elements 146 may be suitable for mobile devices, others for stationary devices, some for high-speed connections, others for low-speed connections, and so on.

Data identifying the one or more selected user interface elements are provided (514) in response to the indication of the user's intention to begin the new interactive session. For example, the session manager 212 can provide data identifying the user interface elements selected by the interface selector 218 to the device 130a and/or to the device 130b. For example, the identifying data can include user interface element identifiers, or can include files, code, or script for deploying the interface elements. In some implementations, one or more selected user interface elements may be presented to a user by default, at the beginning of a new interactive session. For example, when beginning a new interactive session (e.g., a tutoring session), the selected interface element 250a can be presented through the interface 230a to the user 232a (e.g., a student) and through the interface 230b to the assistant 232b (e.g., a tutor). In some implementations, one or more selected user interface elements may be presented to a user during a new interactive session. For example, the interface selector 218 may determine that an interface element is to be recommended or presented to a user during a particular session phase (e.g., in the middle, at the end, etc.), or in association with particular session content. A user interface element, for example, may be recommended or presented when a particular keyword is encountered in an interactive session's content, or when another interface element is employed.

A selection of one or more user interface elements to be employed during the new interactive session may be optionally received (516) from the user. For example, the user 232a may select one or more interface elements 146 (e.g., the interface element 250b) during an interactive session. Session data associated with the new interactive session and configuration data associated with one or more user interface elements selected by the user during the new interactive session may be stored with prior session and configuration data, and may be used to reanalyze the data. For example, information associated with the user's 232a selection of the interface element 250b can be provided to the interactive session system 140 for storage with session data 142 associated with the new interactive session 240c. Data associated with the interactive session 240c may be aggregated with data associated with the prior interactive sessions 240a and 240b, for example, when analyzing the session data 142 to identify interface elements 146 to be recommended or presented during future interactive sessions.

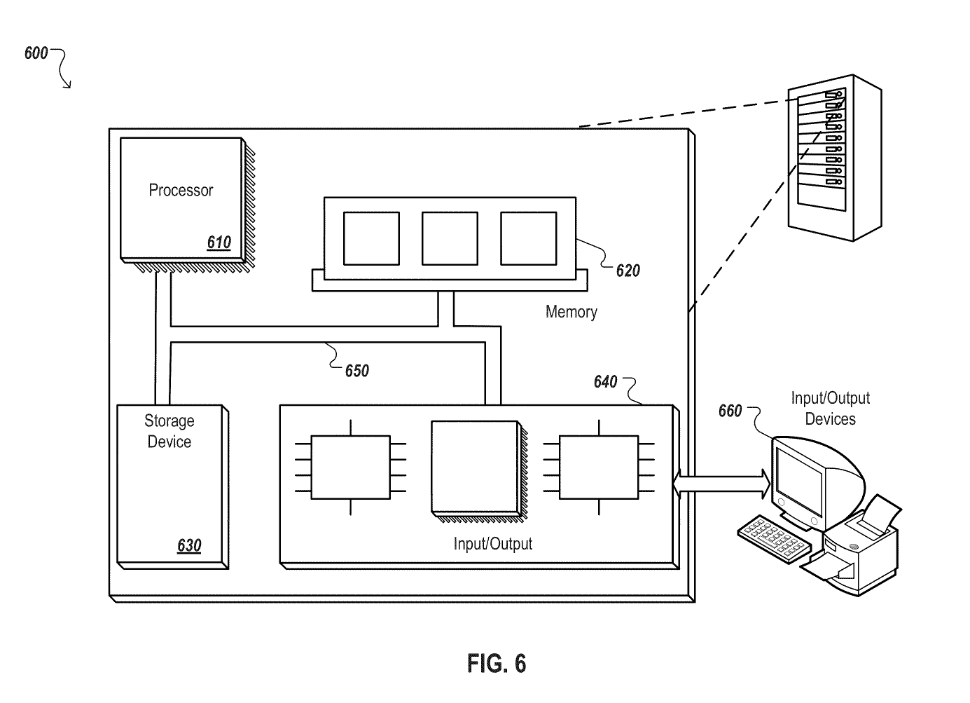

FIG. 6 is a block diagram of an example data processing apparatus 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices (e.g., an Ethernet card), a serial communication device (e.g., an RS-232 port), and/or a wireless interface device (e.g., an 802.11 card). In another implementation, the input/output device can include driver devices configured to receive input data and send output data to other input/output devices 660 (e.g., keyboard, printer, and display devices). Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. However, a computer need not have such devices. Moreover, a computer can be embedded in another device, e.g., a mobile telephone, a smart phone, a mobile audio or video player, a game console, a Global Positioning System (GPS) receiver, and a wearable computer device, to name just a few. Devices suitable for storing computer program instructions and data include all forms of non-volatile memory, media and memory devices, including by way of example semiconductor memory devices, magnetic disks, and the like. The processor and the memory can be supplemented by, or incorporated in, special purpose logic circuitry.

To provide for interaction with a user, embodiments of the subject matter described in this specification can be implemented on a computer having a display device for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input and output.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
identifying, by one or more data processing apparatus, prior session data associated with a set of prior interactive sessions, each interactive session being an online session during which a task was performed and being associated with a corresponding session category, and wherein at least two different session categories are associated with prior interactive sessions;
identifying, for each interactive session in the set of prior interactive sessions, prior configuration data associated with a set of user interface elements employed during the interactive session;
receiving, from a user, an indication of an intention to begin a new interactive session belonging to one of the corresponding session categories;
selecting, by one or more data processing apparatus, one or more user interface elements to be presented to the user during the new interactive session, based at least in part on an analysis of the prior session data and the prior configuration data associated with the corresponding session category to which the new interactive session belongs; and
providing, by one or more data processing apparatus, data identifying the one or more selected user interface elements in response to the indication of the user's intention to begin the new interactive session.

2. The method of claim 1, comprising receiving a search query associated with a particular task, wherein a session category is associated with the new interactive session, based at least in part on the search query.

3. The method of claim 1, comprising identifying one or more tasks performed during the new interactive session, wherein a session category is associated with the new interactive session, based at least in part on the tasks.

4. The method of claim 1, comprising identifying content associated with the new interactive session, wherein a session category is associated with the new interactive session, based at least in part on the content.

5. The method of claim 1, comprising identifying a participant associated with the new interactive session, wherein a session category is associated with the new interactive session, based at least in part on the participant.

6. The method of claim 1, wherein selecting one or more user interface elements is based at least in part on an analysis of a portion of the prior session data and the prior configuration data associated with prior interactive sessions in which the user has previously participated.

7. The method of claim 1, comprising receiving information associated with a context of a computing device employed by the user, wherein selecting one or more user interface elements is based at least in part on an analysis of a portion of the prior session data and the prior configuration data associated with prior interactive sessions in which similar computing devices were used in a similar context.

8. The method of claim 1, wherein the one or more user interface elements are to be presented to the user by default, at the beginning of the new interactive session.

9. The method of claim 1, wherein the analysis of the prior session data and the prior configuration data includes submitting session parameters and configuration parameters to a machine learning model, and wherein selection of one or more user interface elements occurs when a confidence value produced by the machine learning model exceeds a predetermined confidence threshold.

10. The method of claim 1, comprising:
receiving, from the user, a selection of one or more user interface elements to be employed during the new interactive session;
storing, with the prior session data and prior configuration data, session data associated with the new interactive session and configuration data associated with the one or more user interface elements selected by the user during the new interactive session; and
reanalyzing the prior session data and prior configuration data.

11. A computer-readable storage device storing software comprising instructions executable by one or more computers which, upon such execution, cause the one or more computers to perform operations comprising:
identifying, by one or more data processing apparatus, prior session data associated with a set of prior interactive sessions, each interactive session being an online session during which a task was performed and being associated with a corresponding session category, and wherein at least two different session categories are associated with prior interactive sessions;
identifying, for each interactive session in the set of prior interactive sessions, prior configuration data associated with a set of user interface elements employed during the interactive session;
receiving, from a user, an indication of an intention to begin a new interactive session belonging to one of the corresponding session categories;
selecting, by one or more data processing apparatus, one or more user interface elements to be presented to the user during the new interactive session, based at least in part on an analysis of the prior session data and the prior configuration data associated with the corresponding session category to which the new interactive session belongs; and
providing, by one or more data processing apparatus, data identifying the one or more selected user interface elements in response to the indication of the user's intention to begin the new interactive session.

12. The device of claim 11, wherein selecting one or more user interface elements is based at least in part on an analysis of a portion of the prior session data and the prior configuration data associated with prior interactive sessions in which the user has previously participated.

13. The device of claim 11, comprising receiving information associated with a context of a computing device employed by the user, wherein selecting one or more user interface elements is based at least in part on an analysis of a portion of the prior session data and the prior configuration data associated with prior interactive sessions in which similar computing devices were used in a similar context.

14. The device of claim 11, wherein the analysis of the prior session data and the prior configuration data includes submitting session parameters and configuration parameters to a machine learning model, and wherein selection of one or more user interface elements occurs when a confidence value produced by the machine learning model exceeds a predetermined confidence threshold.

15. The device of claim 11, comprising:
receiving, from the user, a selection of one or more user interface elements to be employed during the new interactive session;
storing, with the prior session data and prior configuration data, session data associated with the new interactive session and configuration data associated with the one or more user interface elements selected by the user during the new interactive session; and
reanalyzing the prior session data and prior configuration data.

16. A system comprising:
one or more computers; and
a computer-readable medium tangibly embodying a computer program product comprising instructions to cause the one or more computers to perform operations comprising:
identifying, by one or more data processing apparatus, prior session data associated with a set of prior interactive sessions, each interactive session being an online session during which a task was performed and being associated with a corresponding session category, and wherein at least two different session categories are associated with prior interactive sessions;
identifying, for each interactive session in the set of prior interactive sessions, prior configuration data associated with a set of user interface elements employed during the interactive session;
receiving, from a user, an indication of an intention to begin a new interactive session belonging to one of the corresponding session categories;
selecting, by one or more data processing apparatus, one or more user interface elements to be presented to the user during the new interactive session, based at least in part on an analysis of the prior session data and the prior configuration data associated with the corresponding session category to which the new interactive session belongs; and
providing, by one or more data processing apparatus, data identifying the one or more selected user interface elements in response to the indication of the user's intention to begin the new interactive session.

17. The system of claim 16, wherein selecting one or more user interface elements is based at least in part on an analysis of a portion of the prior session data and the prior configuration data associated with prior interactive sessions in which the user has previously participated.

18. The system of claim 16, wherein the operations comprise receiving information associated with a context of a computing device employed by the user, wherein selecting one or more user interface elements is based at least in part on an analysis of a portion of the prior session data and the prior configuration data associated with prior interactive sessions in which similar computing devices were used in a similar context.

19. The system of claim 16, wherein the analysis of the prior session data and the prior configuration data includes submitting session parameters and configuration parameters to a machine learning model, and wherein selection of one or more user interface elements occurs when a confidence value produced by the machine learning model exceeds a predetermined confidence threshold.

20. The system of claim 16, wherein the operations comprise:
receiving, from the user, a selection of one or more user interface elements to be employed during the new interactive session;
storing, with the prior session data and prior configuration data, session data associated with the new interactive session and configuration data associated with the one or more user interface elements selected by the user during the new interactive session; and
reanalyzing the prior session data and prior configuration data.
